(19) United States
(12) Patent Application Publication
(10) Pub. No.: US 2007/0115937 A1
(43) Pub. Date: May 24, 2007

(54) NETWORK DEVICE AND METHOD FOR TESTING VOICE QUALITY AND COMMUNICATION SYSTEM USING THE SAME

(75) Inventors: KUN-YI WU, Tu-Cheng,Taipei Hsien (TW); YEW-MIN LO, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,934

(22) Filed: May 29, 2006

(30) Foreign Application Priority Data
Nov. 18, 2005 (TW) 094140647

(51) Int. Cl. H04L 12/66

(52) U.S. Cl. 370/352

(57) ABSTRACT

A network device for testing voice quality is provided. The network device includes a parsing module, a test module and a processing module. The parsing module is for receiving a data packet transmitted over the Internet and parsing data in the data packet. The test module is for comparing parsed data with corresponding parameters in a parameter list, and sending a test signal according to a comparison result. The processing module is for outputting a processing signal to a remote manager based on the test signal. A communication system is also provided. A method for testing the voice quality is further provided.

### FIELD OF THE INVENTION

The invention relates to a network device, and more particularly to a network device with voice quality test function.

### DESCRIPTION OF RELATED ART

VoIP (Voice over Internet Protocol) protocol utilizes an open network to transmit video and audio data. Since real-time voice transmission over a network is implemented by connecting a traditional Public Switched Telephone Network (PSTN) telephone to the Internet via a network device such as a voice gateway, a user only needs to pay an Internet fee and a local call fee while making a long-distance call. Therefore, communication fees for long-distance calling using the VoIP are much lower than those incurred when using a conventional long-distance carrier via the PSTN telephone.

However, due to the instability of the Internet, voice quality with VoIP is less stable than with conventional means, therefore a network phone provider is required to test voice quality with each VoIP call in real time to ensure quality. A traditional solution is connecting a voice gateway with a Voice Quality Tester (VQT). Thus, each voice gateway needs a corresponding VQT, thereby increasing the overall network cost.

### SUMMARY OF THE INVENTION

A network device for testing voice quality is provided. The network device includes a parsing module, a test module and a processing module. The parsing module is for receiving a data packet transmitted over the Internet and parsing data in the data packet. The test module is for comparing parsed data with corresponding parameters in a parameter list, and sending a test signal according to a comparison result. The processing module is for outputting a processing signal to a remote manager based on the test signal.

A communication system is also provided. The communication system includes Internet, a network device, and a terminal device. The network device is for testing voice quality, and includes a parsing module, a test module, and a processing module. The parsing module is for receiving a data packet transmitted over the Internet and parsing data in the data packet. The test module is for comparing parsed data with corresponding parameters in a parameter list, and sending a test signal according to a comparison result. The processing module is for outputting a processing signal to a remote manager based on the test signal. The terminal device is connected to the Internet via the network device.

A method for testing voice quality is further provided. The method includes receiving a data packet from the Internet, parsing data of the data packet, reading corresponding parameters in a parameter list, comparing parsed data of the data packet with the corresponding parameters in the parameter list to test whether the parsed data are normal, and sending a processing signal if the parsed data of the data packet is abnormal.

Other advantages and novel features will become more apparent from the following detailed description when taken in conjunction with the accompanying drawings, in which:

### BRIEF DESCRIPTION OF THE DRAWINGS

FIG. 1 illustrates an application environment of a network device in accordance with a exemplary embodiment of the invention;

FIG. 2 is a block diagram of the network device of FIG. 1;

FIG. 3 is a parameter list in accordance with the exemplary embodiment of the invention;

FIG. 4 is a flow chart of a voice quality test method in accordance with another embodiment of the invention; and

FIG. 5 is a detailed flow chart of the voice quality test method of FIG. 4.

### DETAILED DESCRIPTION OF THE INVENTION

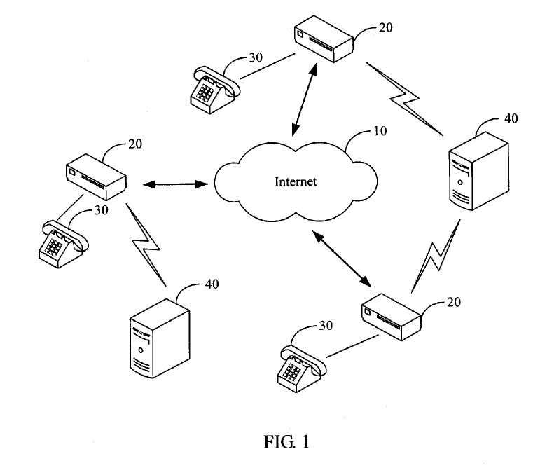

FIG. 1 illustrates an application environment of a network device 20 in accordance with a exemplary embodiment of the invention. A plurality of terminal devices 30 are connected to the Internet 10 via several network devices 20, and communicate with each other over the Internet 10. The network device 20 also communicates with a remote manager 40. In this embodiment, the terminal device 30 is a Public Switched Telephone Network (PSTN) telephone, the network device 20 is a voice gateway with voice test function, and the remote manager 40 is a server.

The network device 20 transforms a telephone signal from the terminal device 30 into a data packet, and transmits the data packet to another network device 20 over the Internet 10. After receiving the data packet, the network device 20 transforms the data packet into the telephone signal and transmits the telephone signal to another terminal device 30 connected therewith, thereby a communication between different terminal devices 30 is established. In the process of communicating between different terminal devices 30, the network device 20 tests voice quality in real time, and then sends a processing signal to the remote manager 40. In this embodiment, the data packet is a real-time protocol/real-time control protocol (RTP/RTCP) data packet.

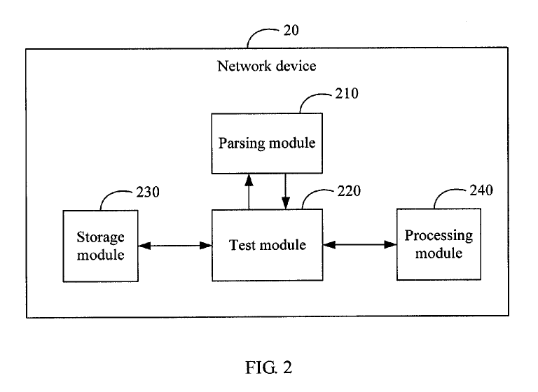

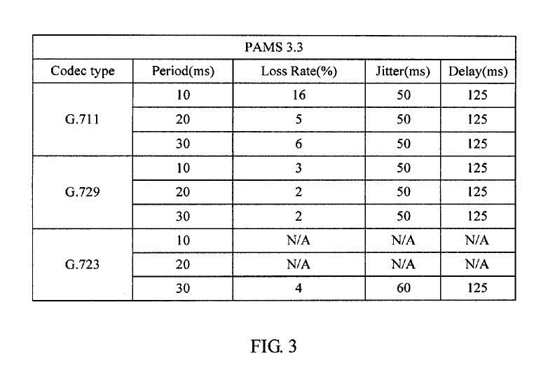

FIG. 2 is a block diagram of the network device 20 of FIG. 1. The network device 20 includes a parsing module 210, a test module 220, a storage module 230, and a processing module 240. The parsing module 210 is for receiving a data packet transmitted over the Internet 10 and parsing data in the data packet. In this embodiment, parsed data include codec type, along with period, loss rate, jitter, and time delay of the data packet. The test module 220 is for comparing the parsed data with corresponding parameters in a parameter list (shown in FIG. 3), and sending a test signal based on a comparison result. The storage module 230 is connected with the test module 220, and is for storing the parameter list. In this embodiment, the storage module 230 is a flash memory. The processing module 240 is for outputting the processing signal to the remote manager 40 according to the test signal.

FIG. 3 is a parameter list in accordance with the exemplary embodiment of the invention. The perceptual analysis measurement system (PAMS) is employed as a standard of testing the voice quality. The PAMS has different values representing accuracy of different voice quality tests. The larger a PAMS value is, the higher the accuracy of the voice quality test will be. In this embodiment, the parameter list is built based on the PAMS value of 3.3. The parameter list includes three types of codec standards: G.711, G.729 and G.723. Each of the three standards corresponds to the loss rate, the jitter and the time delay for periods of 10 ms, 20 ms, and 30 ms. For example, when the codec type is G.711 and the period is 10 ms, the loss rate, the jitter and the time delay are 16%, 50 ms, and 125 ms respectively.

Upon receiving the parsed data of the data packet from the parsing module 210, the test module 220 compares the parsed data of the data packet with corresponding parameters in the parameter list. In this embodiment, the codec type and the period of the data packet are G711 and 10 ms, respectively. The test module 220 first determines whether the loss rate of the data packet is greater than that (16%) in the parameter list. If the loss rate of the data packet is greater than that in the parameter list, this indicates the loss rate of the data packet is abnormal, and the test module 220 sends the test signal to the processing module 240. The processing module 240 then outputs the processing signal to the remote manager 40 based on the test signal. If the loss rate of the data packet is smaller than that in the parameter list, this indicates the loss rate of the data packet is normal, and the test module 220 then determines whether the jitter of the data packet is greater than that (50 ms) in the parameter list.

If the jitter of the data packet is greater than that in the parameter list, this indicates the jitter of the data packet is abnormal, and the test module 220 sends the test signal to the processing module 240. The processing module 240 then outputs the processing signal to the remote manager 40 based on the test signal. If the jitter of the data packet is less than that in the parameter list, this indicates the jitter of the data packet is normal, and the test module 220 then determines whether the time delay of the data packet is longer than that (125 ms) in the parameter list.

If the time delay of the data packet is longer than that in the parameter list, this indicates the time delay of the data packet is abnormal, and the test module 220 sends the test signal to the processing module 240. The processing module 240 then outputs the processing signal to the remote manager 40 based on the test signal. If the time delay of the data packet is shorter than that in the parameter list, this indicates the time delay of the data packet is normal, the test module 220 then resends the request to the parsing module 210, and the next data packet is tested. In other words, if the parsed data of all data packets are normal, voice quality can be guaranteed.

In this embodiment, the processing signal sent by the processing module 240 may be a Syslog packet or a Trap packet, which can be set based on a user's request. When the parsed data of the data packet is regarded as abnormal, the processing module 240 sends the Syslog packet or the Trap packet to the remote manager 40, in order to notify the remote manager 40 to perform processing and maintenance, thereby ensuring the voice quality of each telephone in the network.

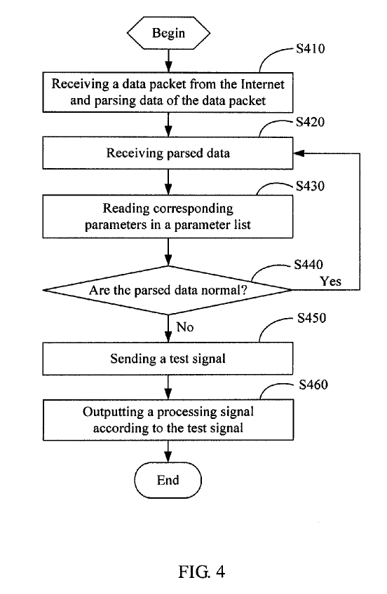

FIG. 4 is a flow chart of a voice quality test method in accordance with another exemplary embodiment of the invention. In step S410, the parsing module 210 receives the data packet from the Internet 10 and parses the data of the data packet. In step S420, the test module 220 receives the parsed data from the parsing module 210. In step S430, the test module 220 reads the corresponding parameters in the parameter list from the storage module 230. In step S440, the test module 220 compares the parsed data of the data packet with the corresponding parameters in the parameter list to determine whether the parsed data are normal. If the parsed data are normal, the process returns to step S420. If the parsed data are abnormal, the process proceeds to step S450, where the test module 220 sends the test signal to the processing module 240 according to a comparison result. In step S460, the processing module 240 outputs the processing signal to the remote manager 40 based on the test signal.

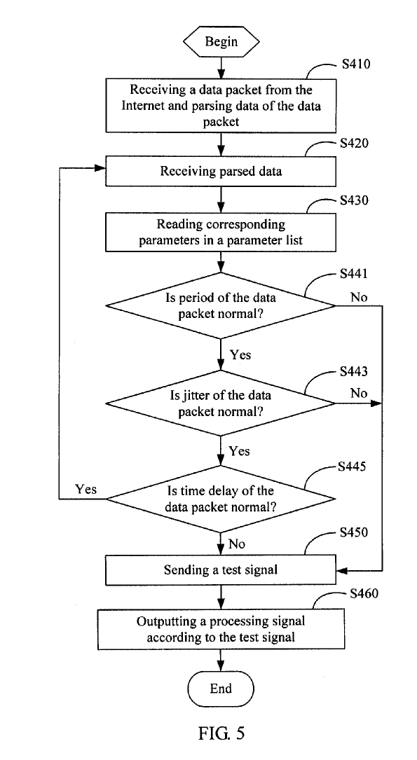

FIG. 5 illustrates a detailed flow chart of the voice quality test method of FIG. 4. The flowchart of FIG. 5 is similar to that of FIG. 4, but shows more detailed steps for implementing step S440 of FIG. 4. In step S441, the test module 220 compares the period of the data packet with that in the parameter list, in order to determine whether the period of the data packet is normal. If the period of the data packet is abnormal, the process proceeds to step S450 described above. If the period of the data packet is normal, the process proceeds to step S443, where the test module 220 compares the jitter of the data packet with that in the parameter list, in order to determine whether the jitter of the data packet is normal. If the jitter of the data packet is abnormal, the process proceeds to step S450 described above. If the jitter of the data packet is normal, the process proceeds to step S445, where the test module 220 compares the time delay of the data packet with that in the parameter list, in order to determine whether the time delay of the data packet is normal. If the time delay of the data packet is abnormal, the process proceeds to step S450 described above. If the time delay of the data packet is normal, the process returns to step S420, where the test module 220 receives data of the next data packet from the parsing module 210. If the time delay of the data packet is abnormal, the process proceeds to step S450 described above.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device for testing voice quality, comprising:
a parsing module for receiving a data packet transmitted over the Internet and parsing data in the data packet;
a test module for comparing parsed data with corresponding parameters in a parameter list, and sending a test signal according to a comparison result; and
a processing module for outputting a processing signal to a remote manager based on the test signal.

2. The network device according to claim 1, further comprising a storage module for storing the parameter list.

3. The network device according to claim 1, wherein the data packet is a real-time protocol/real-time control protocol (RTP/RTCP) data packet.

4. The network device according to claim 3, wherein the data in the data packet comprise codec type, along with period, loss rate, jitter, and time delay of the data packet.

5. The network device according to claim 1, wherein the parameter list is built based on a perceptual analysis measurement system (PAMS) value of 3.3.

6. The network device according to claim 1, wherein the processing signal is a Syslog packet.

7. The network device according to claim 6, wherein the processing signal is a Trap packet.

8. A communication system for voice communication, comprising:
Internet;
a network device for testing voice quality, comprising:
a parsing module for receiving a data packet transmitted over the Internet and parsing data in the data packet;
a test module for comparing parsed data with corresponding parameters in a parameter list, and sending a test signal according a comparison result; and
a processing module for outputting a processing signal to a remote manager based on the test signal; and
a terminal device, which is connected to the Internet via the network device.

9. The communication system according to claim 8, wherein the network device further comprises a storage module for storing the parameter list.

10. The communication system according to claim 9, wherein the data packet is a real-time protocol/real-time control protocol (RTP/RTCP) data packet.

11. The communication system according to claim 10, wherein the data packet comprise codec type, along with period, loss rate, jitter and time delay of the data packet.

12. The communication system according to claim 9, wherein the parameter list is built based on a Perceptual Analysis Measurement System (PAMS) value of 3.3.

13. The communication system according to claim 8, wherein the processing signal is a Syslog packet.

14. The communication system according to claim 13, wherein the processing signal is a Trap packet.

15. A method for testing voice quality, comprising steps of:
receiving a data packet from the Internet;
parsing data of the data packet;
reading corresponding parameters in a parameter list;
comparing parsed data of the data packet with the corresponding parameters in the parameter list to test whether the parsed data are normal;
sending a testing signal according to a comparison result if the parsed data of the data packet is abnormal; and
outputting a processing signal based on the test signal.

16. The method according to claim 15, further comprising receiving the parsed data of a next data packet if the parsed data of the data packet is normal.

17. The method according to claim 15, wherein the step of comparing parsed data of the data packet with the corresponding parameters in the parameter list to test whether the parsed data are normal comprises steps of:
comparing a period of the data packet with that in the parameter list to test whether the period of the data packet is normal;
comparing a jitter of the data packet with that in the parameter list to test whether the jitter of the data packet is normal if the period of the data packet is normal; and
comparing a time delay with of the data packet with that in the parameter list to test whether the time delay of the data packet is normal if the jitter of the data packet is normal.

18. The method according to claim 17, wherein the step of comparing parsed data of the data packet with the corresponding parameters in the parameter list to test whether the parsed data are normal further comprises sending a processing signal if the time delay of the data packet is abnormal.

19. The method according to claim 18, wherein the step of comparing parsed data of the data packet with the corresponding parameters in the parameter list to test whether the parsed data are normal further comprises sending the processing signal if the jitter of the data are abnormal.

20. The method according to claim 19, wherein the step of comparing parsed data of the data packet with the corresponding parameters in the parameter list to test whether the parsed data are normal further comprises sending the processing signal if the period of the data packet is abnormal.
